(19) United States
(12) Patent Application Publication
(10) Pub. No.: US 2016/0357193 A1
(43) Pub. Date: Dec. 8, 2016

(54) MOBILE ULTRA WIDE BAND CONSTELLATIONS

(71) Applicant: 5D Robotics, Inc., Carlsbad, CA (US)

(72) Inventors: David Bruemmer, Carlsbad, CA (US); Josh Senna, Carlsbad, CA (US); Akshay Kumar Jain, Carlsbad, CA (US)

(73) Assignee: 5D Robotics, Inc., Carlsbad, CA (US)

(21) Appl. No.: 15/170,720

(22) Filed: Jun. 1, 2016

Related U.S. Application Data
(60) Provisional application No. 62/169,689, filed on Jun. 2, 2015.

(51) Int. Cl. G05D 1/10; G01S 5/02

(52) U.S. Cl. CPC G05D 1/101; G01S 5/0289; G01S 2013/466

(57) ABSTRACT

A mobile positional constellation system determines a mobile device's relative position using a plurality of UWB transceivers affixed to a platform. The platform, which itself can be mobile, includes a plurality of UWB transceivers and a trilateration module. The mobile device, which can also have one or more UWB transceivers, exchanges one or more signals with the platform to determine a relative position with respect to the platform through trilateration. With an established relative position established behavior of the mobile device can be augmented. The synchronous capability of UWB signals provides a user with direct control of a mobile device in austere conditions including those in which GPS is denied.

### RELATED APPLICATION

The present application relates to and claims the benefit of priority to U.S. Provisional Patent Applications No. 62/169,689 filed Jun. 2, 2015, which is hereby incorporated by reference in its entirety for all purposes as if fully set forth herein

### BACKGROUND OF THE INVENTION

### Field of the Invention

Embodiments of the present invention relate, in general, to a mobile Ultra-Wide-Band (“UWB”) constellation, and more particularly to the formation of a local positional frame of reference using UWB transceivers for use by an Unmanned Aircraft System (“UAS”).

### Relevant Background.

Trilateration is the ability to identify an object's location by measuring the range from a plurality of transmitters of a known position. The Global Positioning System (“GPS”) uses a method known as “trilateration” to measure the differences in the time it takes for a common signal transmitted from different satellites to reach a given receiver. While the establishment and refinement of GPS has tremendously advanced the ability to determine an object's position, this system is not without its limitations.

Significantly, GPS requires a direct, line-of-sight path between the receiver and at least four GPS satellites. GPS can thus become unreliable in urban environments, mountainous terrain, inside buildings, underground, etc. Moreover, interference in the electromagnetic spectrum in which GPS signals are being transmitted can degrade or deny positional data.

It is also possible to determine an object's relative location using trilateration. Using three or more local transmitters, all having known locations, the location of the object can be determined. For example, a mobile telephone can be found based on its receipt and transmission of signals, if these signals are received by three or more towers. Knowing the positions of those towers on a map, the object's relative location can be overlaid on the map, transforming its local (or relative) position to a geospatial reference frame.

But these resources are also limited. Redundant or overlapping transmitters are infrequent and they too suffer substantially from line-of-sight requirements. Moreover, the location of such towers is fixed and the capital infrastructure needed for each additional tower is significant. The need, then, is a mobile local or relational positional system that can integrate with a geospatial positioning system to provide robust and reliable positional information regardless of environmental conditions.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

A mobile positional constellation system, according to one embodiment of the present invention includes a mobile platform, an UAS, a plurality of UWB transceivers fixedly connected to the mobile platform wherein each of the plurality of UWB transceivers is affixed to the mobile platform at a different location, a trilateration module communicatively coupled to each of the plurality of UWB transceivers, a positional sensor coupled to the mobile platform, and a map module. The UAS, which can also have one or more UWB transceivers, exchanges one or more signals with the mobile platform to determine a current UAS relative position with respect to the mobile platform through trilateration. At the same time the positional sensor can determine a geospatial frame of reference for the mobile platform and the map module, which is communicatively coupled to the trilateration module, can combine the UAS relative position and the geospatial frame of reference for the mobile platform.

The mobile positional constellation system of the present invention also includes a behavior module that is communicatively coupled to the map module and the UAS. The behavior module directs the UAS from the current UAS relative position to a UAS target position. The UAS target position is, in one instance of the present invention, based on the geospatial frame of reference. In another embodiment of the present invention the behavior module is communicatively coupled to a user interface and input from the user interface can command the behavior module to direct the current UAS relative position to a user defined UAS relative position based on the geospatial frame of reference.

In another embodiment of the present invention, a mobile positional constellation system includes a mobile platform, an UAS that includes a plurality of UAS UWB transceivers and wherein each of the transceivers is affixed to the UAS at a different location, at least one UWB transceiver fixedly positioned to the mobile platform, a trilateration module, communicatively coupled to each of the plurality of UWB transceivers, that determines a current mobile platform relative position with respect to the UAS through trilateration, a positional sensor coupled to the UAS that determines a geospatial frame of reference for the UAS, and a map module communicatively coupled to the trilateration module that combines the mobile platform relative position and the geospatial frame of reference for the UAS.

This embodiment can further include comprising a behavior module communicatively coupled to the map module and the mobile platform wherein the behavior module directs the mobile platform from the current mobile platform relative position to a mobile platform target position and wherein the mobile platform target position is based on the geospatial frame of reference.

In addition, a user interface can be included that can command the behavior module to direct the current mobile platform relative position to a user defined mobile platform relative position based on the geospatial frame of reference.

In another embodiment of the present invention, a method for establishing a mobile positional frame of reference includes the steps of positioning four or more UWB transceivers on a mobile platform wherein each UWB transceiver is positioned on the mobile platform at a different location. The method continues by affixing at least one UWB transceiver on an UAS and determining a mobile platform geospatial frame of reference using a positional sensor, transmitting a signal from the UWB affixed to the UAS. Each UWB transceiver positioned on the mobile platform receives the signal and determines a UAS relative position from the mobile platform using trilateration based on the signal received at each UWB transceiver positioned on the mobile platform. Thereafter UAS relative position is combined with the mobile platform geospatial frame of reference and a UAS geospatial frame of reference determined.

The above method further includes directing the UAS from a current UAS relative position to a UAS target position and wherein the UAS target position is based on the mobile platform geospatial frame of reference. In addition, input from the user interface can command the behavior module to direct the current UAS relative position to a user defined UAS relative position based on the geospatial frame of reference

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a depiction of a mobile positional constellation system in use, according to one embodiment of the present invention;

FIG. 2 shows high level depiction of trilateration using four distinct range determinations;

FIG. 3 shows a high level block diagram of mobile positional constellation system according to one embodiment of the present invention;

FIG. 4 shows as high depiction of the employment of UAS in a GPS denied environment using the mobile positional constellation system of the present invention;

FIG. 5 shows a high level block diagram of components associated with a UAS or similar device that would be in communication with a mobile platform using the positional constellation system of the present invention; and

FIG. 6 is a flowchart of method for establishing a mobile positional frame of reference, according to one embodiment of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

Using a constellation of UWB transceivers, a mobile platform can establish itself as a base station from which the relative position of another mobile device can be determined. Using a plurality of UWB transceivers, or tags, a signal transmitted from a mobile device can be received by each tag and thereafter compared to ascertain the mobile device's relative position.

The platform itself can also include a geospatial sensor to enable the platform to ascertain its geospatial location. With the platform's geospatial location known, the relative location of the mobile device can be combined with the geospatial location of the mobile platform to ascertain the geospatial location of the mobile device, despite the mobile device's inability to autonomously determine its geospatial location.

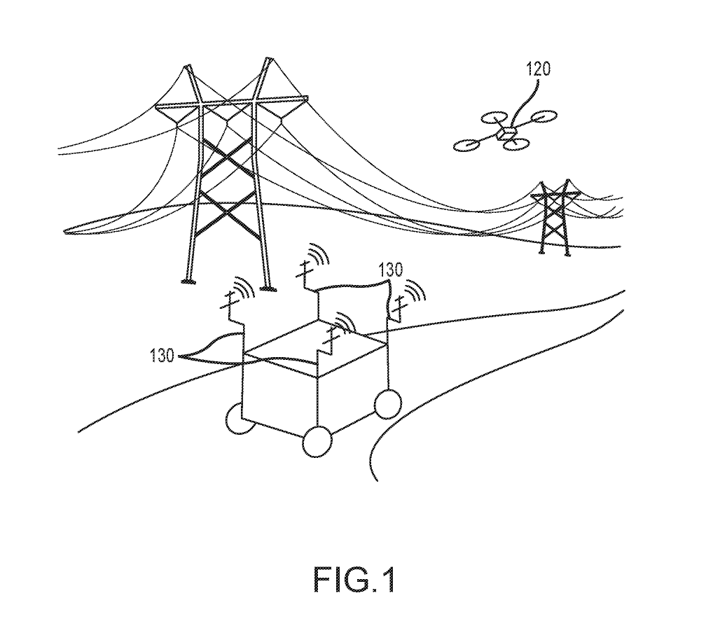

FIG. 1 shows a depiction of a mobile positional constellation system in use, according to one embodiment of the present invention. A first device or mobile platform 110 includes a plurality of UWB transceivers 130 that are each positioned at different locations of the platform. While the figure shows four antenna representative of UWB transceivers, one of reasonable skill in the relative art will recognize that the UWB antenna may be incorporated into the vehicle and may, and are likely, not placed on the same plane so as to increase the diversity of the signal reception.

The image shown in FIG. 1 includes a second device 120 which, in this case, is a UAS. As will be understood by way of the examples presented below, the invention provides a means by which to establish a mobile relative frame of reference.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “affixed”, “affixed to”, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Various embodiments of the present invention identify the relative position of a mobile device relative to a mobile platform. In one instance the mobile device can be a UAS, or “drone”—that is, an aircraft without a human aboard. A UAS may operate with varying degrees of autonomy, from operating directly under remote control by a human operator to operating fully autonomously, using onboard computers. The term Unmanned Aerial System (“UAS”) emphasizes the importance of elements other than the aircraft. It includes elements such as ground control stations, data links and other support equipment. A similar term is an unmanned-aircraft vehicle system (UAVS) remotely piloted aerial vehicle (RPAV), remotely piloted aircraft system (RPAS) and remotely piloted aircraft systems (RPAS).

Another feature of the present invention is the use of UWB transceivers. UWB is a wireless technology for transmitting large amounts of digital data over a wide spectrum of frequency bands with very low power for a short distance. UWB radios not only can carry a huge amount of data over a short distance at very low power (less than 0.5 mw), but have the ability to carry signals through doors and other obstacles that tend to reflect signals at more limited bandwidths and a higher power. UWB can be compared with other short-distance wireless technologies, such as Bluetooth, which is the standard for connecting handheld wireless devices with other similar devices and with desktop computers.

UWB broadcasts digital pulses that are timed very precisely on a carrier signal across a very wide spectrum (number of frequency channels) at the same time. Transmitter and receiver must be coordinated to send and receive pulses with an accuracy of trillionths of a second. Because of the ultra-precise pulse timing and signal recognition characteristics of receivers, UWB signals operate well below the noise thresholds of conventional RF signals, precluding interference with the same.

One aspect of the present invention is the use of one or more active position UWB transceivers or tags. As suggested above, active tag tracking is not limited to line-of-sight signal paths and is not vulnerable to conventional jamming. These UWB radio frequency (RF) identification (ID) tag systems (collectively RFID) comprise a reader with an antenna, a transmitter, and software such as a driver and middleware. One function of the UWB RFID system is to retrieve state and positional information (ID) generated by each tag (also known as a transponder). Tags are usually affixed to objects so that it becomes possible to locate where the object is without direct line-of-sight, given the wide-frequency nature of the UWB transmission. A UWB tag can include additional information other than the ID. A single tag can also be used as a beacon for returning to a specific position or carried by an individual or vehicle to affect a follow behavior from other like equipped objects. As will be appreciated by one of reasonable skill in the relevant art, other active ranging technology is equally applicable to the present invention and is contemplated in its use. The use of the term “UWB”, “tags” or “RFID tags,” or the like, is merely exemplary and should not be viewed as limiting the scope of the present invention.

In one implementation of the present invention, a RFID and/or UWB tag cannot only be associated with a piece of stationary infrastructure with a known, precise, position, but also provide active relative positioning between movable objects. For example, even if the two or more tags are unaware of their precise geospatial position that can provide accurate relative position. Moreover, the tag can be connected to a centralized tracking system to convey interaction data. As a mobile object interacts with the tag of a known position, the variances in the object's positional data can be refined. Likewise, a tag can convey not only relative position between objects but relative motion between objects as well. Such tags possess low-detectability and are not limited to line of sight nor are they vulnerable to jamming. And, depending on how mounted and the terrain in which they are implemented, a tag and tracking system can permit user/tag interaction anywhere from 200 feet to a range of two miles. Currently, tags offer relative position accuracy of approximately +/−12 cm for each interactive object outfitted with a tag. As will be appreciated by one or reasonable skill in the relevant art, the use of the term object is not intended to be limiting in any way. While the present invention is described by way of examples in which objects may be represented by vehicles or platforms, an object is to be interpreted as an arbitrary entity that can implement the inventive concepts presented herein. For example, an object can be a robot, vehicle, UAS, aircraft, ship, bicycle, or other device or entity that moves in relation to another. The collaboration and communication described herein can involve multiple modalities of communication across a plurality of mediums.

The active position UAW tags of the present invention can also provide range and bearing information. Using triangulation and trilateration between tags, a route can be established using a series of virtual waypoints. Tags can also be used to attract other objects or repulse objects creating a buffer zone. For example, a person wearing a tag can create a 4-foot buffer zone which will result in objects not entering the zone to protect the individual. Similarly, a series of tags can be used to line a ditch or similar hazard to ensure that the object will not enter a certain region. According to one or more embodiments of the current invention, multiple ranges between the active position tags can be used to create a mesh network of peer to peer positioning where each element can contribute to the framework. Each module or object can vote as to its own position and subsequently the relative position of its nearest neighbors. Importantly, the invention provides a means of supplementing the active tags with ranges to other landmarks. Thus when other active modules or objects are not present, not visible or not available, other sensors/modalities come into play to complement a mesh network.

A constellation is simply a group or association of objects. For the purpose of the present invention a constellation is a grouping of UWB transceivers that enable two mobile devices determine their relative position. The actual positioning of each UWB transceiver on an object may vary and, as discussed below, may have a fixed position to enable further refinement of the determination of a mobile device.

Also included in the description are flowcharts depicting examples of the methodology which may be used to establish a mobile positional frame of reference. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for establishing a mobile frame of reference through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

According to one embodiment the present invention, a plurality of UWB transceivers are fixedly connected to a mobile platform such as a vehicle. The position of each UWB transceiver on the platform and relative to each other is known. As each UWB transceiver transmits a signal and receives signals from the other UWB transceivers of the constellation, the UWB can calibrate their measurements to accommodate any noise or environmental conditions.

A mobile device such as a UAS can, according to another embodiment of the present invention, be associated with one or more additional UWB transceivers. A signal sent from the UAS UWB transceiver will be received at each mobile platform UWB. However, each UWB transceiver on the mobile platform will receive the signal at a slightly different time. The constellation of UWB transceivers of the mobile platform are communicatively coupled to a trilateration module which can identify the signal received separately by each UWB transceiver on the mobile platform was the same signal. Each UWB transceiver, however, received the signal with a different time-of-flight.

The time-of-flight of the signal is determined from two references to a synchronized clock. When the signal is generated and sent by the mobile device UWB transceiver, the signal is encoded with a time-stamp. As the signal is received, the receiving UWB on the mobile platform also checks the time to determine a time-of-flight of the signal. According to one embodiment of the present invention, timing coherency of the present invention enables the present invention to detect minimal differences in the signal's time-of-flight.

According to one embodiment of the present invention, each UWB transceiver is capable of time resolution of roughly 60 picoseconds (60 trillionths of a second) at the speed of light, which equates to approximately 2 centimeters (cm). However, as each receiver is positioned close to each other, a small error in the range (time-of-flight) results in a large error in positioning. Therefore, while the UWB transceivers are individually capable of a resolution of as little as 2 cm, this theoretical limit is not practically attainable. Even so, more accurate position determinations of the mobile platform can be made if the separation between the UWB transceivers on the mobile platform is 15 cm or more.

If, for example, the mobile platform includes four UWB transceivers mounted at known locations on the platform and if each clock on each UWB transceiver is synchronized, then for each signal a range and unique time-of-flight can be determined. In other embodiments both range and bearing can be determined. With four separate range measurements (reception of a signal from the mobile device), combined with a synchronized clock a single signal “conversation” (i.e., the signal interactions between two or more UWB transceivers) results in four ranges that can be analyzed to determine a relative position. Thus a single signal pulse will determine the mobile device's exact location.

In the interest of clarity, the present invention, in one embodiment, uses trilateration of UWB-generated signals to determine the relative position of a mobile device from a mobile platform.

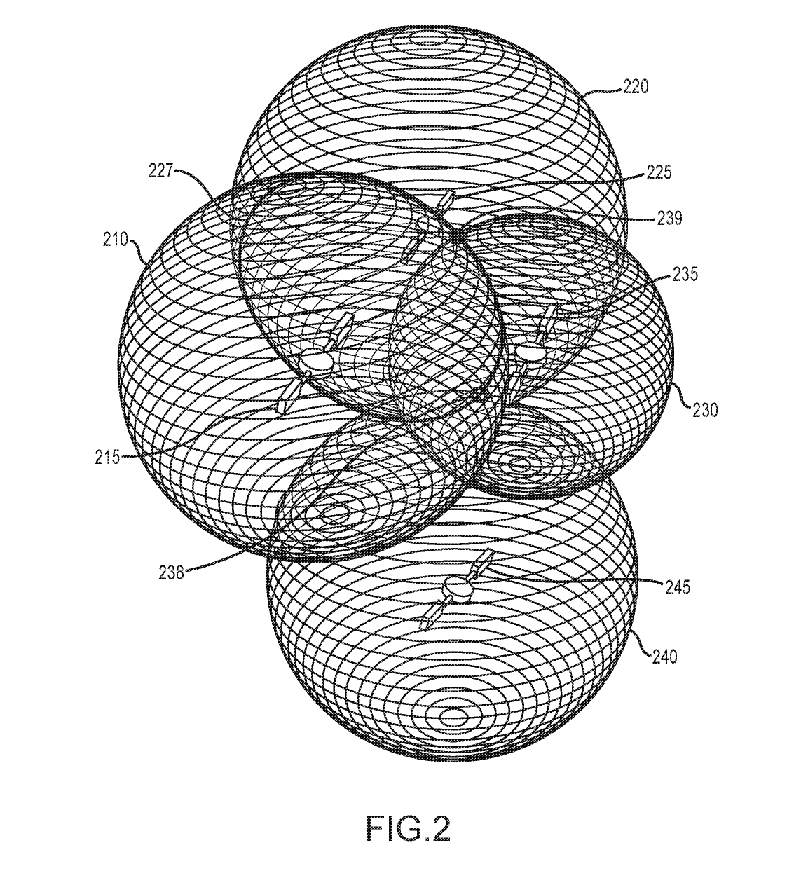

Trilateration is, with reference to FIG. 2, in essence, an examination of the intersection of spheres wherein the shell of each sphere represents the time-of-flight of a given signal in terms of distance (distance equals the rate times the time-of-flight, and in this case the rate is the speed of the signal, which is the speed of light) from the signal's origin. A given time-of-flight thus equates to a given distance; tracing that distance out in three-dimensional space from a single point yields a sphere. Consider the following example. An observer who is 10 miles from “Satellite A” 215, could be anywhere on the surface of a huge, imaginary sphere 210 with a 10-mile radius, with Satellite A at its center. If the observer is also 15 miles from “Satellite B” 225, the observer knows he/she must be somewhere on the intersection of those spheres, and that intersection is a circle 227. If the observer is also a known the distance to a third satellite 235, the intersection of the third sphere 230 with the other two will yield two possible points 238, 239. A fourth sphere 240 formed by a fourth satellite 245 narrows the result to a single point 238. Two-dimensional trilateration works in a similar way, by pinpointing an observer's position on a map by measuring the precise distances from three known landmarks and tracing out time-of-flight circles from these landmarks: The observer is located where the three circles intersect.

This is precisely how a Global Positioning System (“GPS”) receiver calculates its position. It does so by precisely timing the signals sent by GPS satellites high above the Earth. Each satellite continually transmits messages that include the time the message was transmitted and the satellite position at time of message transmission.

The receiver uses the messages it receives to determine the transit time of each message and computes the distance or range to each satellite. These distances, along with the satellites' locations, are used to compute the position of the receiver. A satellite's position and range define a sphere, centered on the satellite, with radius equal to the range. The position of the receiver is somewhere on the surface of this sphere. Thus, with four satellites, the indicated position of the GPS receiver is at or near the intersection of the surfaces of four spheres. In the ideal case of no errors, the GPS receiver would be at a precise intersection of the four surfaces.

One of the most significant error sources is the GPS receiver's clock. Because of the very large value of the speed of light, c, the estimated distances from the GPS receiver to the satellites, the range, are very sensitive to errors in the GPS receiver clock; for example, an error of one microsecond (0.000001 second) corresponds to an error of 300 meters (980 foot). This suggests that an extremely accurate and expensive clock is required for the GPS receiver to work; however, manufacturers prefer to build inexpensive GPS receivers for mass markets. This dilemma is resolved by taking advantage of the fact that there are four very large ranges.

With GPS the intersection of the first two spheres is normally quite large, and thus, the third sphere surface is likely to intersect this large circle at two very distinct locations. If the clock is wrong, it is very unlikely that the surface of the sphere corresponding to the fourth satellite will initially intersect either of the two points of intersection of the first three, because any clock error could cause it to miss intersecting a point. On the other hand, if a solution has been found such that all four spherical surfaces at least approximately intersect with a small deviation from a perfect intersection, then it is quite likely that an accurate estimation of receiver position will have been found and that the clock is quite accurate.

One of reasonable skill in the relevant art will appreciate that the current system is distinct from that of a GPS system. First there is not a single receiver by rather a plurality of receivers. Secondly, the distances between the receivers is small as compared to that of a system such as GPS. The constellation of a plurality of UWB transceivers enables the determination of a mobile device's relative position within a limited range, accurately and reliably.

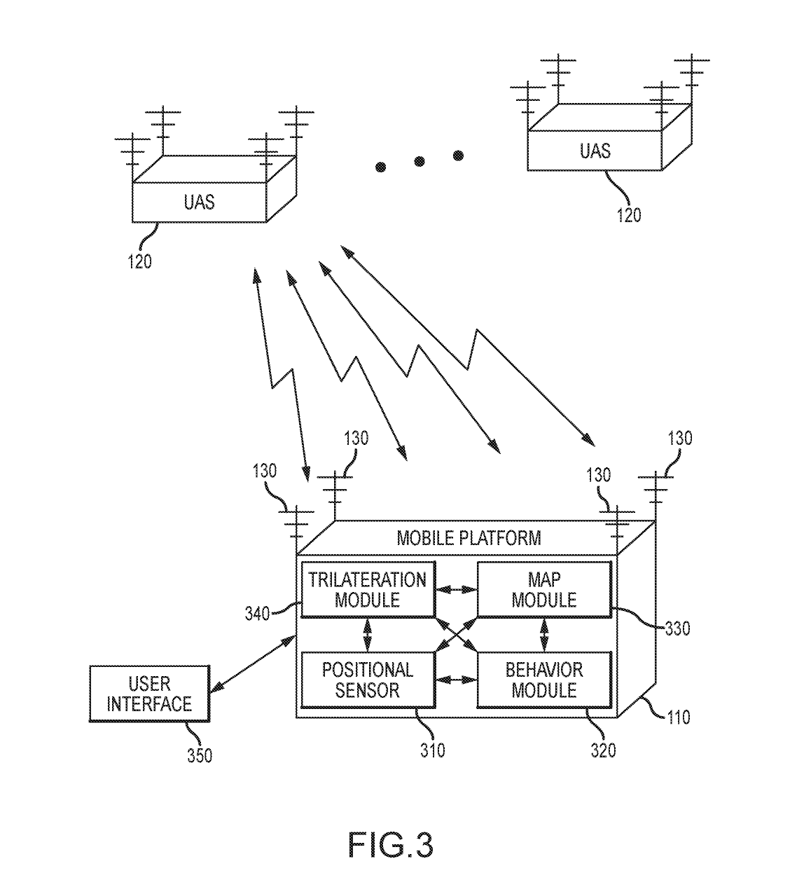

FIG. 3 shows a high level block diagram of mobile positional constellation system according to one embodiment of the present invention. A mobile platform 110 is communicatively coupled to a user interface 350 and one or more mobile devices 120 such as a UAS. Each mobile platform includes a plurality of UWB transceivers 130, a trilateration module 340, a map module 330, a behavior module 320 and a positional sensor module 310. These modules work in concert to establish a local frame of reference for the UAS so that it can operate within the confine or oversight of the mobile platform including those regions in which normal positional sensors may not be reliable.

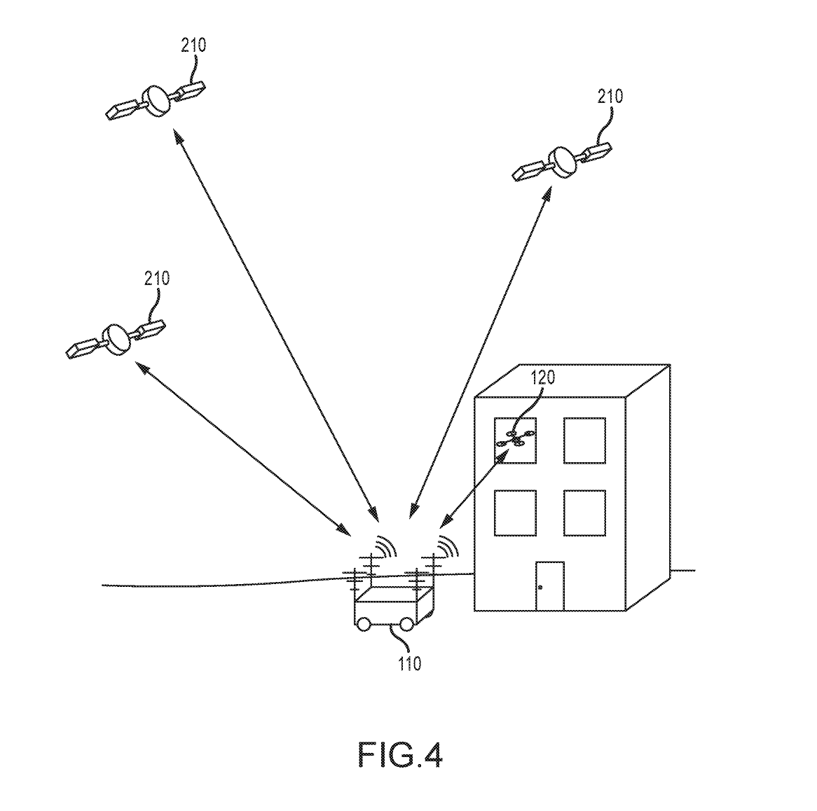

FIG. 4 shows as high depiction of the employment of UAS in a GPS denied environment using the mobile positional constellation system of the present invention. In this depiction the mobile platform 110 can receive a geospatial reference from a plurality of GPS satellites 210. The mobile device 120 however has been deployed to an area that is denied GPS signals. The present invention enables the mobile platform to merge geospatial data with that of a UAS or mobile device while it operates in a GPS denied region.

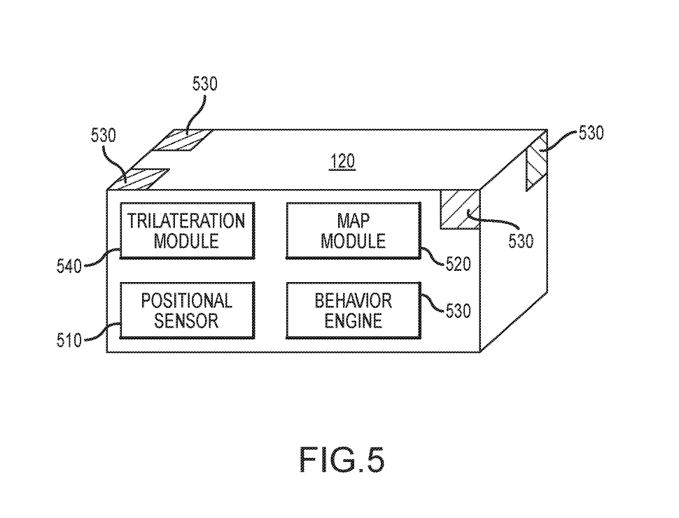

Like the base platform, the mobile device 120 can also possess the capability to establish a positional frame of reference and peer-to-peer positioning. FIG. 5 shows a high level block diagram of components associated with a UAS or similar device that would be in communication with a mobile platform using the positional constellation system of the present invention. The mobile device 120 includes a plurality of UWB transceivers 530, a trilateration module 540, a map module 520, a positional sensor 510 and a behavior engine 530.

Consider the following example to better illustrate the novelty and usefulness of the present invention. Urban areas throughout the world typically include an intricate system of storm drains and underground conduits. The maintenance and upkeep of such systems is critical and each urban environment spends substantial time and funds to periodically inspect their system. In most cases such an infrastructure is inspected manually and visually. That is to say, an individual goes down into the system and visually inspects the culvert, pipe or sewer. And while some of these pipes are large enough to accommodate a person, most are not.

According to one embodiment of the present invention a small UAS can be positioned at the access point to such a tunnel or culvert. At the same point is a mobile platform. As the UAS travels the length of the pipe its position to relative to the mobile platform can be accurately determined. The UAS can be equipped with other sensors suitable for the task it is undertaking such as a cameral or other equipment to identify whether the drain is intact or in need of repair. As the UAS travels down the pipe the mobile platform can mirror its location on the surface and by doing so ascertain its precise relative location. In other words, the precise location of the pipe.

Should the UAS identify a problem within the pipe, the mobile platform, which can possess a geospatial frame of reference, can identify exactly where the problem exists. Thus if there is a break in the line or something else that needs to be repaired in between access points, the mobile platform can determine the location of the UAS exactly. While shallow pipes and infrastructure can be found using traditional radio signals, the present invention enables a UAS to extend hundreds of meters with no requirement for direct line of sight communication.

In another embodiment the UAS or mobile device can include two or more UWB transceivers the produce signals from different points of the UAS. By knowing at what location these UWB tags are positioned, the mobile base station cannot only determine the relative location of the UAS, but also its orientation. This enables the present invention to navigate the UAS as well as determine its position. And the synchronization of the UWB transceivers provides all this information with a single range conversation: range/bearing (equivalent to x/y position) and heading of the UAS.

Moreover, multiple UAS or similar mobile devices can interface with a mobile platform to enable simultaneous tasking of multiple UAS devices for swarming or coordinated motions. In addition, each UAS and the mobile platform can include a behavior engine to direct the activity of the device. A behavior engine receives inputs from various sensors and data sources and uses that information in combination with predetermined conflict resolution protocols to determine a course of action. A behavior engine may receive a task to move from point A to point B but in establishing the path recognize using sensor data that there is an object such as a hole in the path that may put the robot at risk. A self preservation mode may override the path directive and divert the robot around the hole until the path directive again gains control.

Another application of the present invention is the inspection and validation of utility lines. Periodically, power lines must be inspected to determine whether foliage or other obstacles present a threat to the operation of the power line. Power transmission lines can be hundreds of miles long and often cover very remote regions. Currently, manned helicopter missions are tasked to fly along and visually inspect the lines. These flights are tedious and expensive. While roads do not parallel all power line routes there is normally reasonably close access to the power lines. Accordingly, one implementation of the present invention is to task one or more UAS devices to inspect power lines while under positive control of a mobile platform.

At the same time the UAS has the ability to operate autonomously as necessary to collect data with respect to its mission, avoid obstacles in its path and yet remain linked to the mobile platform. The present invention combines the advantages of each device while at the same time reducing their limitations.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

Software programming code, which can embody a portion of the present invention, is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

An exemplary system for implementing the invention includes a general purpose computing device such as the form of a conventional personal computer, a personal communication device or the like, including a processing unit, a system memory, and a system bus that joins various system components, including the system memory to the processing unit. The system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The personal computer may further include a hard disk drive for reading from and writing to a hard disk, a magnetic disk drive for reading from or writing to a removable magnetic disk. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment.

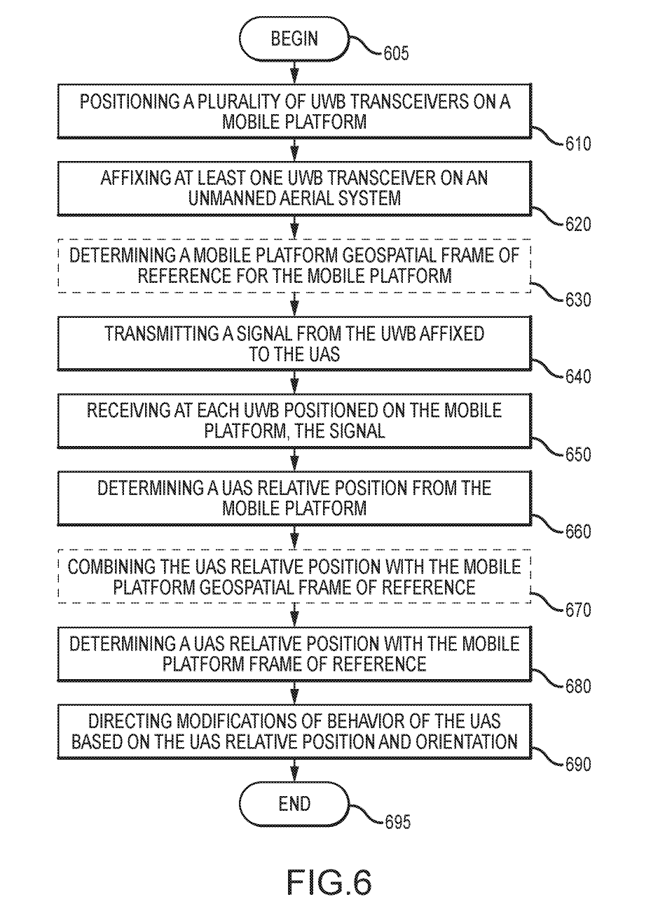

FIG. 6 is a flowchart of method for establishing a mobile positional frame of reference, according to one embodiment of the present invention. The process begins 605 with positioning 610 four or more UWB transceivers on a first device wherein each UWB transceiver is positioned on the device at a different location and affixing 620 at least one UWB transceiver on a second device. Optionally, at this stage, a geospatial frame of reference can be determined 630 using a positional sensor.

The next step is transmitting 640 a signal from the UWB affixed to the second device and thereafter receiving 650, at each UWB transceiver positioned on first device, the signal. From this signal the system can determine 660 a second device relative position and its orientation at an instance in time from the first device using trilateration based. Again, optionally, the mobile device (UAS) relative frame of reference can be combined 670 with the geospatial frame of reference to determine 680 the UAS geospatial frame of reference. Lastly the method concludes 695 by directing 690 modifications of behavior of the second device by the first device based on the second device relative position and orientation.

While there have been described above the principles of the present invention in conjunction with a mobile positional constellation system, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

1. A mobile positional constellation system, comprising:
a mobile platform;
an Unmanned Aircraft System (“UAS”) wherein the UAS includes a UAS Ultra-Wide Band (“UWB”) transceiver and a UAS behavior engine;
a plurality of UWB transceivers fixedly connected to the mobile platform wherein each of the plurality of UWB transceivers is fixedly connected to the mobile platform at a different location;
a trilateration module communicatively coupled to each of the plurality of UWB transceivers wherein the trilateration module determines a current UAS relative position with respect to the mobile platform through trilateration; and
a mobile platform behavior module communicatively coupled to the trilateration module operable to direct the UAS behavior engine based on the current UAS relative position.

2. The mobile positional constellation system of claim 1, further comprising at the mobile platform a positional sensor communicatively coupled to a map module wherein the positional sensor determines a geospatial frame of reference for the mobile platform and the UAS wherein the mobile platform behavior module directs the UAS from the current UAS relative position to a UAS target position and wherein the UAS target position is based on the geospatial frame of reference.

3. The mobile positional constellation system of claim 2, wherein the mobile platform behavior module is communicatively coupled to a user interface.

4. The mobile positional constellation system of claim 3, wherein input from the user interface can command the mobile platform behavior module to direct the current UAS relative position to a user defined UAS relative position based on the geospatial frame of reference.

5. The mobile positional constellation system of claim 1, wherein the positional sensor is a global positioning system sensor.

6. The mobile positional constellation system of claim 1, wherein the positional sensor is a LiDAR positioning sensor

7. The mobile positional constellation system of claim 1, wherein the positional sensor is an inertial navigation unit

8. The mobile positional constellation system of claim 1, wherein the positional sensor is a RADAR based system.

9. The mobile positional constellation system of claim 1, wherein the UAS includes a geospatial positional sensor.

10. The mobile positional constellation system of claim 1, wherein the mobile platform is a vehicle.

11. The mobile positional constellation system of claim 1, wherein the mobile platform is man portable.

12. The mobile positional constellation system of claim 1, wherein the mobile platform is fixed to a structure.

13. The mobile positional constellation system of claim 1, wherein the UAS includes a plurality of UWB transceivers.

14. The mobile positional constellation system of claim 1, wherein the mobile platform behavior model maintains direct control of the UAS.

15. The mobile positional constellation system of claim 1, wherein the UAS behavior engine maintains the current UAS relative position within a predefined range of the mobile platform.

16. The mobile positional constellation system of claim 1, wherein the UAS autonomously docks with the mobile platform.

17. A mobile positional constellation system, comprising:
a mobile platform;
an Unmanned Aircraft System (“UAS”) wherein the UAS includes a plurality of UAS Ultra-Wide Band (“UWB”) transceivers wherein each of the plurality of UWB transceivers is affixed to the UAS at a different location;
at least one UWB transceiver fixedly connected to the mobile platform;
a trilateration module communicatively coupled to each of the plurality of UWB transceivers wherein the trilateration module determines a current mobile platform relative position with respect to the UAS through trilateration; and
a mobile platform behavior module communicatively coupled to the trilateration module operable to direct the UAS behavior engine based on the current UAS relative position.

18. The mobile positional constellation system of claim 17, further comprising a positional sensor coupled to the UAS wherein the positional sensor determines a geospatial frame of reference for the UAS.

19. The mobile positional constellation system of claim 18, further comprising a map module communicatively coupled to the trilateration module operable to combine the mobile platform relative position and the geospatial frame of reference for the UAS.

20. The mobile positional constellation system of claim 17, further comprising a behavior module communicatively coupled to the map module and the mobile platform wherein the behavior module directs the mobile platform from the current mobile platform relative position to a mobile platform target position and wherein the mobile platform target position is based on the geospatial frame of reference.

21. The mobile positional constellation system of claim 17, wherein input from a user interface can command the behavior module to direct the current mobile platform relative position to a user defined mobile platform relative position based on the geospatial frame of reference.

22. The mobile positional constellation system of claim 17, wherein the mobile platform includes a geospatial positional sensor.

23. The mobile positional constellation system of claim 17, wherein the mobile platform is a vehicle.

24. The mobile positional constellation system of claim 17, wherein the mobile platform includes a plurality of UWB transceivers.

25. A mobile positional constellation system, comprising:
a first set of Ultra-Wide Band (“UWB”) transceivers affixed to an Unmanned Aircraft System (“UAS”) wherein the UAS wherein each of the first set of UWB transceiver is affixed to the UAS at a different location;
a second set of UWB transceivers affixed to a base platform wherein each of the second set of UWB transceivers is affixed to the base platform at a different location;
a UAS trilateration module communicatively coupled to each of first set UWB transceivers wherein the UAS trilateration module determines a current base platform relative position with respect to the UAS through trilateration;
a base platform trilateration module communicatively coupled to each of second set UWB transceivers wherein the base platform trilateration module determines a current UAS relative position with respect to the base platform through trilateration;
a map module communicatively coupled to the UAS trilateration module and the base platform operable to combine the current UAS relative position with the current base platform relative position to form a unified relative position; and
a base platform behavior module communicatively coupled to map module and operable to direct a UAS behavior engine based on unified relative position.

26. The mobile positional constellation system of claim 25, further comprising a second base platform and wherein the UAS can establish a second current base platform relative position simultaneously.

27. The mobile positional constellation system of claim 25, further comprising a second UAS and where the base platform can establish a second current UAS relative position simultaneously.

28. A method for establishing a mobile positional frame of reference, comprising the steps:
positioning four or more Ultra-Wide Band (“UWB”) transceivers on a first device wherein each UWB transceiver is positioned on the device at a different location;
affixing at least one UWB transceiver on a second device;
transmitting a signal from the UWB affixed to the second device;
receiving, at each UWB transceiver positioned on first device, the signal;
determining a second device relative position and orientation at an instance in time from the first device using trilateration based on the signal received at each UWB transceiver positioned on the first device;
directing modifications of behavior of the second device by the first device based on the second device relative position and orientation.

29. The method for establishing a mobile positional frame of reference of claim 28 wherein the second device is an Unmanned Aerial System (“UAS”).

30. The method for establishing a mobile positional frame of reference of claim 29, further comprising directing the UAS from a current relative position to a target position and wherein the target position is based on a geospatial frame of reference.

31. The method for establishing a mobile positional frame of reference of claim 28, wherein input from the user interface can command behavior module of the second device based on the second device relative position and orientation.

32. The method for establishing a mobile positional frame of reference of claim 28, further comprising establishing a geospatial frame of reference using a global positioning system sensor.

33. The method for establishing a mobile positional frame of reference of claim 28, further comprising establishing a geospatial frame of reference using a LiDAR positioning sensor.

34. The method for establishing a mobile positional frame of reference of claim 28, further comprising establishing a geospatial frame of reference using an inertial navigation unit

35. The method for establishing a mobile positional frame of reference of claim 28, further comprising establishing a geospatial frame of reference using a RADAR based system.

36. The method for establishing a mobile positional frame of reference of claim 28, wherein the first device is a mobile platform.

37. The method for establishing a mobile positional frame of reference of claim 28, wherein the first device is a fixed structure.

38. The method for establishing a mobile positional frame of reference of claim 28 wherein affixing includes affixing a plurality of UWB transceivers on the second device and receiving includes receiving, at each UWB affixed to the second device a signal from the first device.

39. The method for establishing a mobile positional frame of reference of claim 38 wherein determining includes determining a first device relative position from the first device using trilateration based on the signal received at each UWB transceiver affixed to the second device.
